(19) United States
(12) Patent Application Publication
(10) Pub. No.: US 2003/0108133 A1
(43) Pub. Date: Jun. 12, 2003

(54) Apparatus and method for increasing received signal-to-noise ratio in a transmit reference ultra-wideband system

(76) Inventor: James L. Richards, Fayetteville, TN (US)

Correspondence Address: VENABLE, BAETJER, HOWARD AND CIVILETTI, LLP, P.O. BOX 34385, WASHINGTON, DC, 20043-9998, US

(21) Appl. No.: 10/267,662

(22) Filed: Oct. 10, 2002

Related U.S. Application Data
(60) Provisional application No. 60/328,602, filed on Oct. 11, 2001.

(51) Int. Cl. H04B 1/10

(52) U.S. Cl. 375/351

(57) ABSTRACT

A TR-UWB receiver receives TR pulses comprising reference and data pulses separated by a delay, D. The receiver includes a multiplier having a first input for inputting a data pulse. A delay circuit delays a reference pulse by D and inputs the delayed reference pulse to a second input of the multiplier. An integrator integrates the output of the multiplier. A baseband signal resulted from integrating the output of the multiplier is demodulated for recovering the communicated data. A gating circuit limits the noise captured prior to the integrator, in response to a gating signal generated during a time fixed or variable gating time interval. Also, a feedback circuit combines forward and feedback noise non-coherently to improve received signal-to-noise ratio.

### CROSS REFERENCE TO RELATED APPLICATIONS

Priority to Provisional Application Ser. No. 60/328,602, filed Oct. 11, 2001, is hereby claimed.

### FIELD OF THE INVENTION

Generally, the present invention relates to an ultra-wideband (UWB) radio communications system. More specifically, the invention relates to the transmission, reception, detection, and synchronization of time-separated reference and data pulses that are communicated in a transmitted-reference (TR) pulse train.

### BACKGROUND

Recent advances in communications technology have enabled UWB systems. Typical UWB systems transmit and receive a sequence of very short-duration radio frequency (RF) pulses. Consequently, UWB systems are often referred to as “impulse radios,” although impulses are only one of many types of waveforms available to the technology. Such systems have shown excellent results in positioning and radar applications. Because they have extremely wide bandwidth, UWB systems also offer excellent link budgets.

There are various conventional UWB receiver and transmitter implementations. The UWB transmitters and receivers can employ numerous data modulation (and demodulation) techniques, including amplitude modulation, phase modulation, frequency modulation, pulse-position modulation (PPM) (also referred to as time-shift modulation or pulse-interval modulation) and M-ary versions of these. Coding is commonly used in UWB systems for channelization, energy smoothing in the frequency domain, resistance to interference, and reducing the interference potential to nearby receivers. In PPM-UWB systems, for example, such codes are commonly referred to as time-hopping codes.

Typically, a UWB receiver is a direct conversion receiver with a cross correlator front-end that coherently converts an electromagnetic pulse train to a baseband signal in a single stage. Some UWB systems require accurate time synchronization between the transmitters and receivers. They also must be able to maintain the synchronization over time. In a synchronized receiver (SR) implementation, for example, synchronization must be accurate to within a fraction of the pulse duration. To recover data in one SR implementation, a high accuracy oscillator triggers a correlator to capture pulse energy at a precise time, multiplying the captured energy by a width-controlled template pulse energy. Because the pulse duration is quite small, synchronization parameters are quite stringent, often requiring long acquisition periods. Moreover, because this process samples a section of the waveform at various points, the receiver does not efficiently capture multipath energy. Losses due to multipath can vary up to 30 dB in some environments. Multiple correlator rake-receivers are used to capture some multipath energy. However, such receivers are complex and expensive.

Another conventional implementation is known as transmitted-reference (TR) UWB system. One such TR-UWB system is disclosed in the U.S. patent application Publication Number US 2001/0053175 A1, entitled “ULTRA-WIDEBAND COMMUNICATIONS SYSTEM.” As disclosed, the TR-UWB system transmits and receives data modulated TR pulses comprising pulse pairs whose individual pulses are separated from each other by time intervals, or delays, that are known to the receiver. The receiver correlates the received TR pulses based on the known delay over a finite interval to recover the communicated data without requiring any acquisition time. As a result, TR reception makes synchronization with individual pulses unnecessary.

In addition, TR-UWB received signals can be collected and processed, while providing automatic multipath gain. This is because TR receivers match the multipath ringing with the delayed waveform, and can therefore capture the entire multipath energy. However, this method also captures noise over the pulse intervals. Often, gains from capturing the multipath energy are lost by capturing the noise. Therefore, there exits a need for improving reception of TR-UWB pulses in noisy environments.

### SUMMARY OF THE INVENTION

Briefly, according to one aspect of the present invention, a TR-UWB receiver receives TR pulses comprising reference and data pulses separated by a delay, D. The receiver includes a multiplier having a first input for inputting a data pulse. A delay circuit delays a reference pulse by D and inputs the delayed reference pulse to a second input of the multiplier. An integrator integrates the output of the multiplier. A baseband signal resulting from integration of the output of the multiplier is demodulated for recovering the communicated data.

In one embodiment of the present invention, a gating circuit limits the noise captured prior to the integrator in response to a gating signal generated during a time fixed or variable gating time interval. In one exemplary embodiment, the gating time interval is relative to the timing of the reference and/or data pulses. Also, the gating function in accordance with this aspect of the present invention can be based on a weighting profile.

In another embodiment, a feedback circuit, preferably having a gain of less than 1, combines forward and feedback noise non-coherently to improve received signal-to-noise ratio (SNR). A hybrid approach in accordance with the present invention combines the gating circuit and the feed back circuit. Under this approach, the gating circuit limits the amount of captured noise and the non-coherent addition of the feed back and forward noise further increases the SNR.

According to another aspect of the present invention, a method increases received SNR in a TR-UWB system that receives adjacent or non-adjacent reference and data pulses separated by a delay, D. The data and reference pulses are correlated. The method of the invention limits the amount of noise captured during correlation in response to a gating signal. Also, forward and feedback noise can be combined non-coherently during correlation to increase SNR. In one embodiment, the correlation includes multiplying a data pulse with a delayed reference pulse, integrating the multiplication result, and gating a pulse prior to integrating the multiplication result to limit the captured noise. In another embodiment, the correlation includes feeding back the delayed reference pulse to provide non-coherent addition of forward and feedback noise.

According to yet another aspect of the present invention, a method for receiving TR pulses includes inputting a data pulse to a first input of a multiplier via a first path, and delaying a reference pulse to be inputted to a second input of the multiplier in accordance with a time delay D via a second path. This aspect of the invention increases the SNR of the delayed reference pulse that is presented to the multiplier via the second path. In one embodiment, the SNR is increased by gating at least a portion of the reference pulse, for example, in accordance with a fixed or variable time interval to limit the captured noise. In another embodiment, the SNR is increased by non-coherently combining forward and feedback noise of the delayed and undelayed reference pulses.

### BRIEF DESCRIPTION OF THE DRAWINGS

Other objects and advantages of the invention will become apparent to those skilled in the art from the following detailed description of preferred embodiments, when read in conjunction with the accompanying drawings. Like elements in the drawings have been designated by like reference numerals.

FIG. 1A shows an exemplary TR pulse train communicated between a TR-UWB transmitter and receiver.

FIG. 1B shows another exemplary TR pulse train communicated between a TR-UWB transmitter and receiver.

FIG. 2 shows an exemplary block diagram of a TR-UWB transmitter that generates the TR pulse train of FIG. 1A.

FIG. 3 shows binary modulation of TR pulse pairs representing binary values “1” and “0.”

FIG. 4 shows a block diagram of a conventional TR-UWB receiver.

FIG. 5 shows exemplary waveforms illustrating the operation of the receiver block diagram of FIG. 4.

FIG. 6 shows the noise captured during a correlation period.

FIG. 7 shows a block diagram of a receiver that incorporates one aspect of the present invention.

FIG. 8 shows exemplary fixed gating, variable gating, and a gating profile.

FIG. 9 shows a gating circuit positioned on a delay path of the receiver of FIG. 7.

FIG. 10 shows a gating circuit positioned on a forward path of the receiver of FIG. 7.

FIG. 11 shows a gating circuit positioned at the output of a multiplier prior to the integrator of the receiver FIG. 7.

FIG. 12 shows an exemplary gate timing controller.

FIG. 13 shows a block diagram of a parallel receiver in accordance with another embodiment of the present invention.

FIG. 14 shows an exemplary spectrum spreading code applied to a modulated TR pulse train.

FIG. 15 shows an exemplary differential signaling method in accordance with the present invention.

FIG. 16 shows a block diagram of a receiver that incorporates feedback noise reduction in accordance with the present invention.

FIG. 17 illustrates quench gating in conjunction with feedback noise reduction in accordance with the present invention.

### DETAILED DESCRIPTION OF THE INVENTION

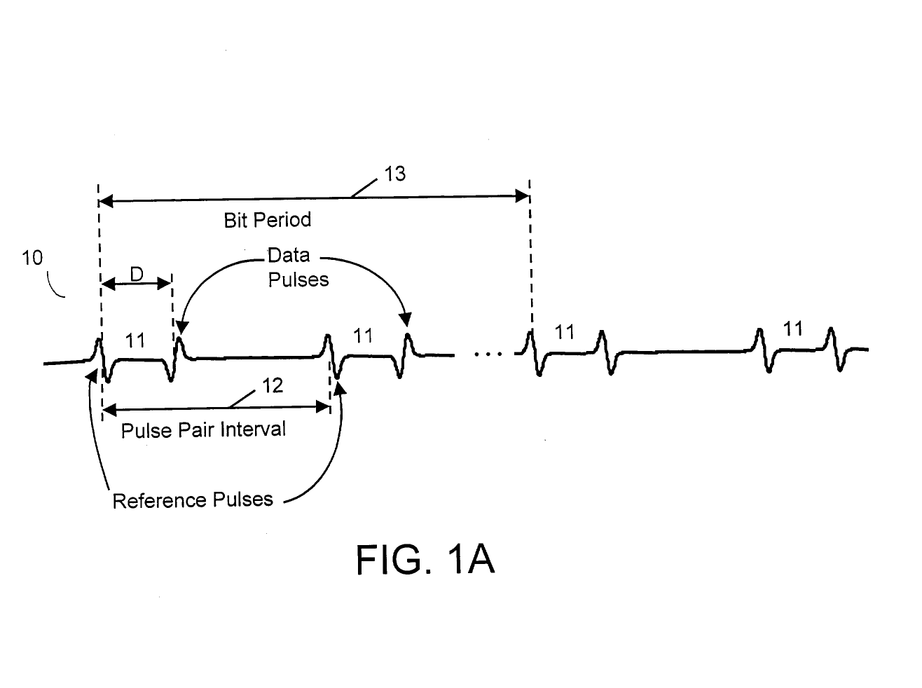

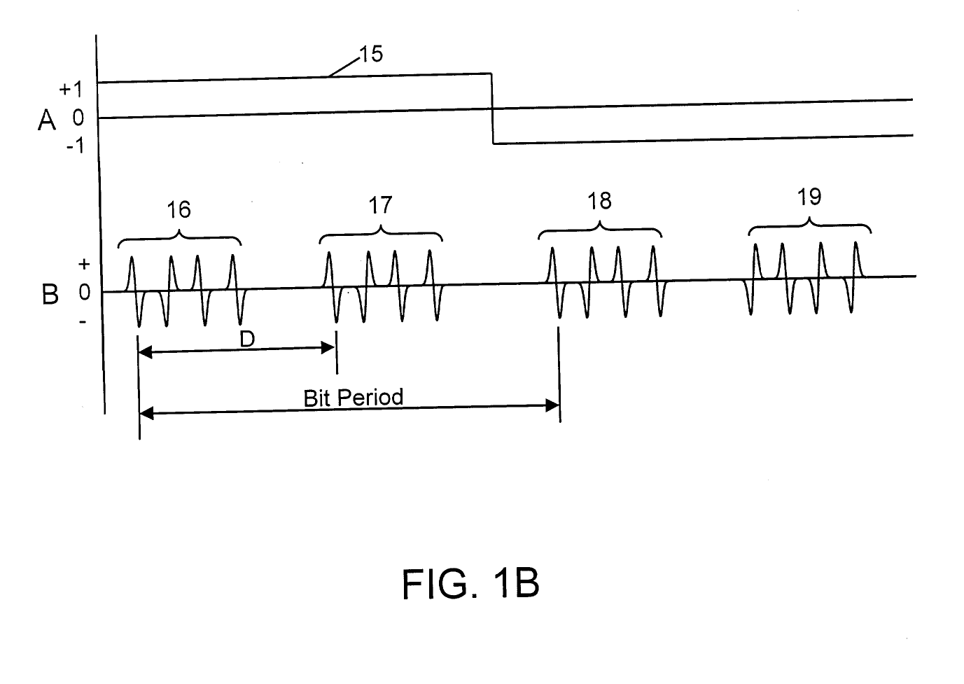

FIG. 1A shows an exemplary TR pulse train 10, which is communicated, between a TR-UWB transmitter and receiver. In one exemplary embodiment, the TR pulse train 10 comprises TR pulse pairs 11 spaced apart according to a pulse pair interval 12. Each TR pulse pair 11 includes reference and data pulses separated by a time delay D that encode binary bits representing communicated messages. The messages could include any one or combination of text, video, images, audio, etc. The pulse pair interval 12 can be held constant or, to reduce spectral comb lines or to achieve channelization, the pulse pair interval 12 can be varied, as might be specified by a code, for example, a time-hopping code. Spectral comb lines can also be reduced or channelization achieved using multiple delays between reference and data pulses as might be specified by a code. In other words, the spacing between pulse pairs may be held constant or may vary and the spacing between reference and data pulses may be held constant or may vary. Furthermore, to reduce spectral comb lines or to achieve channelization, the polarity of the pulses of the pulse train 10 can be varied as might be specified by a code. Generally, various combinations of pulse pair intervals, delays, and pulse polarity patterns can be defined for a TR pulse train 10 to reduce spectral comb lines and to achieve channelization.

FIG. 1A illustrates two types of pulses designated reference pulses and data pulses. Typically, reference pulses are not modulated by data, whereas data pulses are modulated by a data signal in accordance with a chosen modulation type. For example, flip modulation is shown in FIG. 1A. Other forms of modulation such as pulse position modulation can also be used to modulate data pulses. Furthermore, it can be appreciated that the reference and data pulses can be in either order and the order can vary on a pulse pair by pulse pair basis.

One or more TR pulse pairs 11 can represent a data bit. When one pulse pair represents a data bit, the bit period 13 equals the pulse pair interval 12. When more than one pulse pair 11 is associated with a data bit, the bit period 13 encompasses the pulse pair intervals 12 of the pulse pairs 11 associated with the data bit. In this case, the pulse multiplication results may be summed during or after the initial integration to achieve integration gain and improved SNR. This summing, however, results in a lower data rate. For example, at a pulse pair rate of 20 million pulse pairs per second, the data rate could be 20 Mbps using the flip modulation approach shown in FIG. 1A. However, if 1000 pulse pairs were associated with each data bit decision, the data rate would be reduced by 1000 to 20 kbps.

The present invention can use various pulse or wavelet types, including doublets, triplets, N-tuplets, chirps, or pulse bursts with a number of cycles. These pulse or wavelet types may have defined temporal and non-temporal pulse characteristics, e.g., amplitude, width, polarity, etc., which may be specified by one or more codes.

Under another embodiment of the present invention, each pulse pair shown in FIG. 1A is replaced by a pair of pulse trains. FIG. 1B illustrates an exemplary TR-UWB signal comprising pairs of pulse trains in accordance with the present invention. Referring to FIG. 1B, Signal A represents a data modulation signal 15 comprising a “1” followed by a “0” represented by +1 and −1 respectively. Signal B represents a TR-UWB signal comprising a first reference pulse train 16 followed by a first data pulse train 17 representing the data “1”, the first reference pulse train 16 and first data pulse train 17 having the same pattern and same polarity. This sequence is then followed by a second reference pulse train 18, which is followed by a second data pulse train 19 representing the data “0”, the second reference pulse train 18 and second data pulse train 19 having the same pattern but opposite polarity. With this embodiment, each pulse of the reference pulse train is separated from a corresponding pulse of the data pulse train by a time delay D.

TR Transmitter

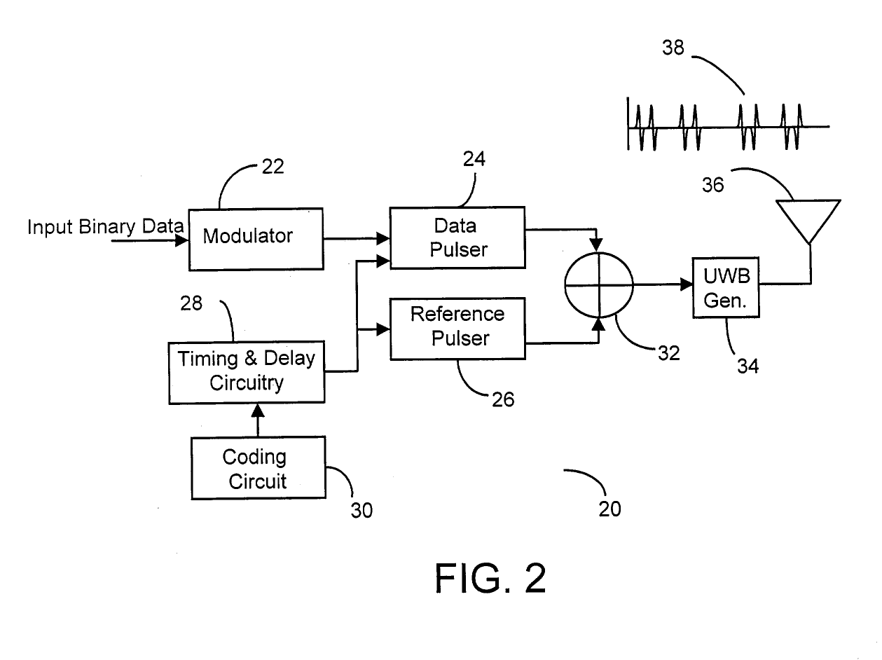

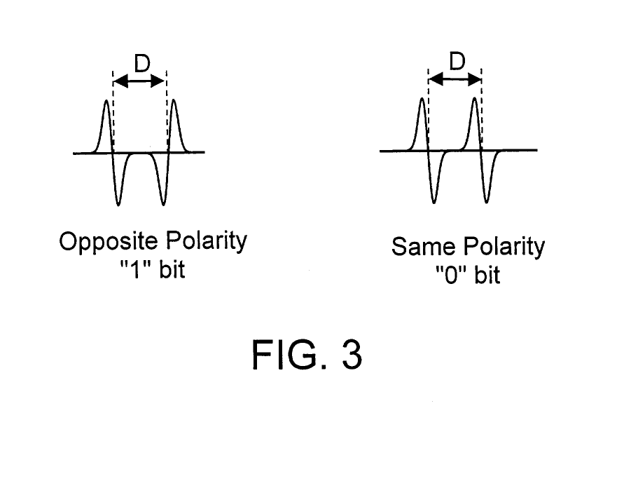

FIG. 2 shows an exemplary TR-UWB transmitter 20 that generates the TR pulse train of FIG. 1A. A modulator 22 receives input binary data. According to one exemplary embodiment, the relative polarity of the reference and data pulses encodes the data. FIG. 3 shows binary modulation of TR pulse pairs representing binary values “1” and “0.” The transmitter 20 includes data pulser circuitry 24 and reference pulser circuitry 26 for generating the data and reference pulses.

The transmitter 20 also includes well-known timing and delay circuitry 28 that controls the transmitter timing. The timing and delay circuitry 28 also delays the reference and data pulses relative to each other. Using well-known delay techniques, the timing and delay circuitry 28 can generate a fixed or variable delay between the reference and data pulses. Moreover, the timing and delay circuitry 28 can generate a plurality of delays for various multiple-access applications. A coding circuit 30 can be used to select the delays in accordance with a coding technique. In a delay hoping scheme, for example, 10 different delays ranging from 5 to 30 ns can be used.

A combiner 32, for example, an OR gate, combines the reference and data pulses to generate a pulse clock. The pulse clock is applied to a UWB pulse generator 34, which is coupled to an antenna 36 to radiate the generated TR pulse trains 38 with or without amplification. In a simple implementation, the reference and data pulses of the transmitted TR pulse train 38 are doublets of the same duration delayed relative to each other by a fixed time interval D.

TR Receiver

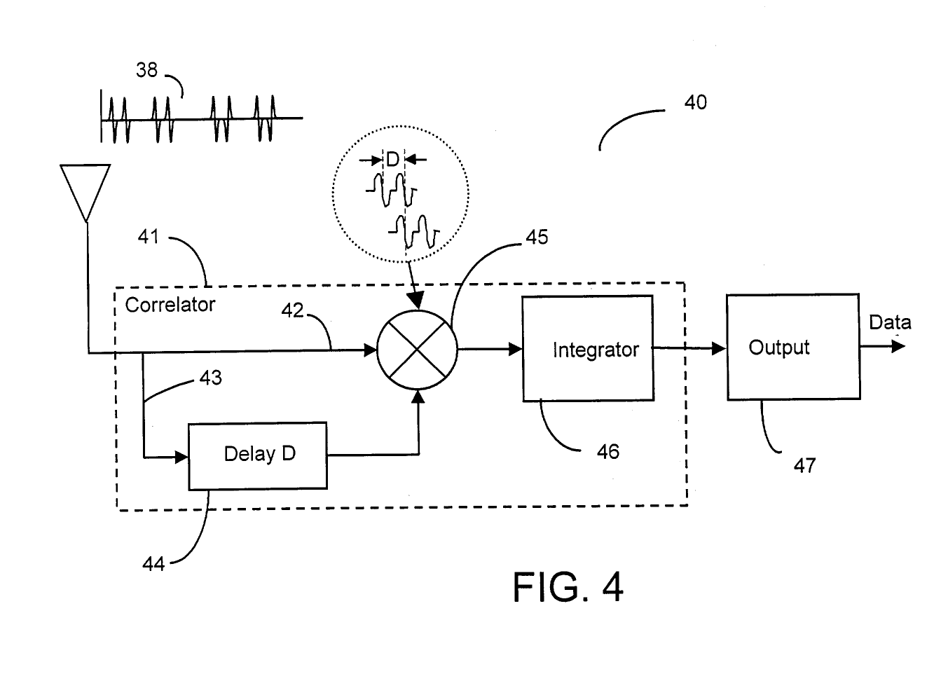

FIG. 4 shows a block diagram of a conventional TR-UWB receiver 40 for receiving the TR pulse train 38. The receiver 40 includes a correlator 41 and an output stage 47. The TR-UWB receiver 40 splits the incoming TR pulses into a forward path 42 and a delay path 43. The delay path 44 includes a delay circuit 44 that delays the incoming TR pulses by a time delay D. The correlator 41 correlates the delayed and non-delayed TR pulses. The correlation process involves multiplication of the delayed and non-delayed pulses by a multiplier 45 and integration by an integrator 46. Usually, to decode each bit multiple TR pulse pairs are correlated and summed. The output stage 47 recovers the transmitted binary data.

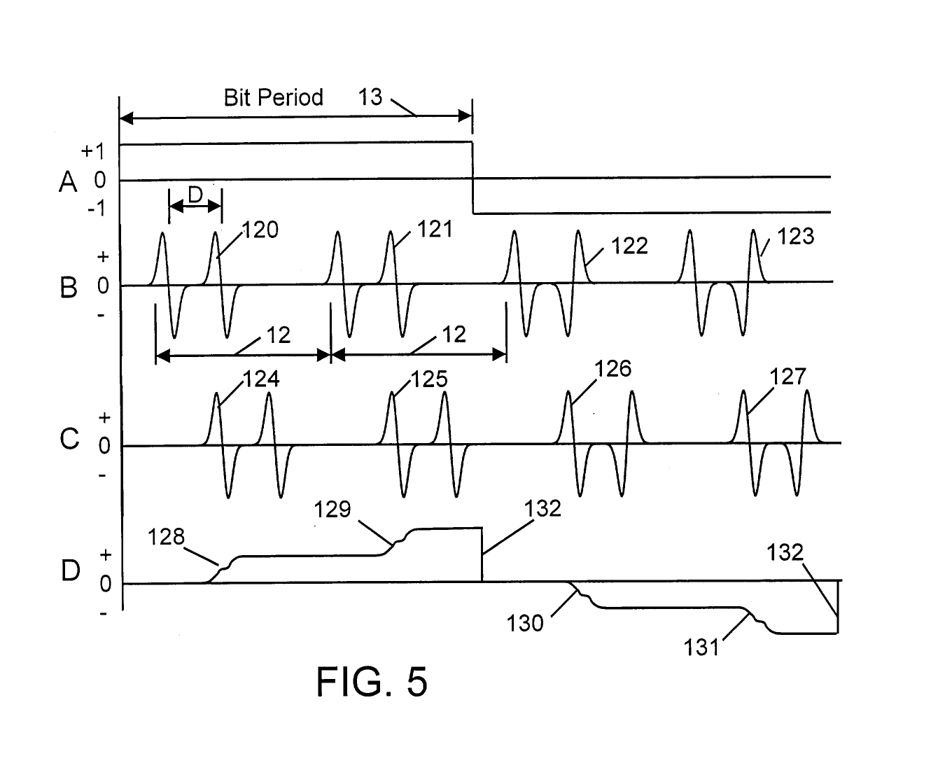

FIG. 5 depicts exemplary waveforms illustrating the operation of the receiver block diagram of FIG. 4. Referring to FIG. 5, Signal B represents a received TR signal 38 on forward path 42 as presented to one input of multiplier 45. Signal B comprises four pulse pairs having reference and data pulses separated by time delay D and constant pulse pair interval 12. The bit period 13 is shown, for example, to encompass two pulse pairs. For each pulse pair shown in FIG. 5, the first pulse is a reference pulse and the second pulse is a data pulse. Thus, the reference pulses have the same polarity for both data polarities indicated by Signal A and the data pulses have polarities matching the data polarities shown by Signal A.

Signal C represents a delayed copy of Signal B as processed by delay circuit 44. It can be seen that the reference pulses 124, 125, 126, and 127 of Signal C arrive at the multiplier 45 at the same time as the data pulses 120, 121, 122, and 123 of Signal B. Signals B and C are multiplied by multiplier 45 and the output is integrated by the integrator 46. Signal D represents the output of the integrator 46. Thus, the data pulses of Signal B are multiplied by the reference pulses of Signal C giving integrated results 128, 129, 130, and 131 of Signal D. Signal D also includes an integrator reset 132 in accordance with the bit period 13 as detected by the output stage 47.

The TR pulse train 38 radiates over a link that has a link budget defined by Equation (1):

$${p}_{e , TR} = Q ( \sqrt{\frac{{N}_{p}}{2 {T}_{p} W}} \frac{1}{2} \frac{{E}_{p}}{{N}_{0}} ) \\ \begin{matrix}{E}_{p} = energy per pulse \\ {N}_{0} = noise power spectral density \\ {N}_{p} = number of pulses per bit \\ {T}_{p} = avg . pulse repitition time = 100 ns \\ W = two \text{-} sided ideal low \text{-} pass filter bandwidth = 4 GHz\end{matrix} \qquad ( 1 )$$

As described above, conventional TR receivers, such as receiver 40, impose a SNR penalty, because the correlation captures noise over the entire data bit interval. The SNR penalty is due to having both signal and noise present on both paths. The unmodulated reference pulse accounts for a loss of 3 dB. The noise multiplier, i.e., noise times noise term in Equation (1), also adds 3 dB loss. Thus, the integrator receives high noise levels during the entire sampling time interval.

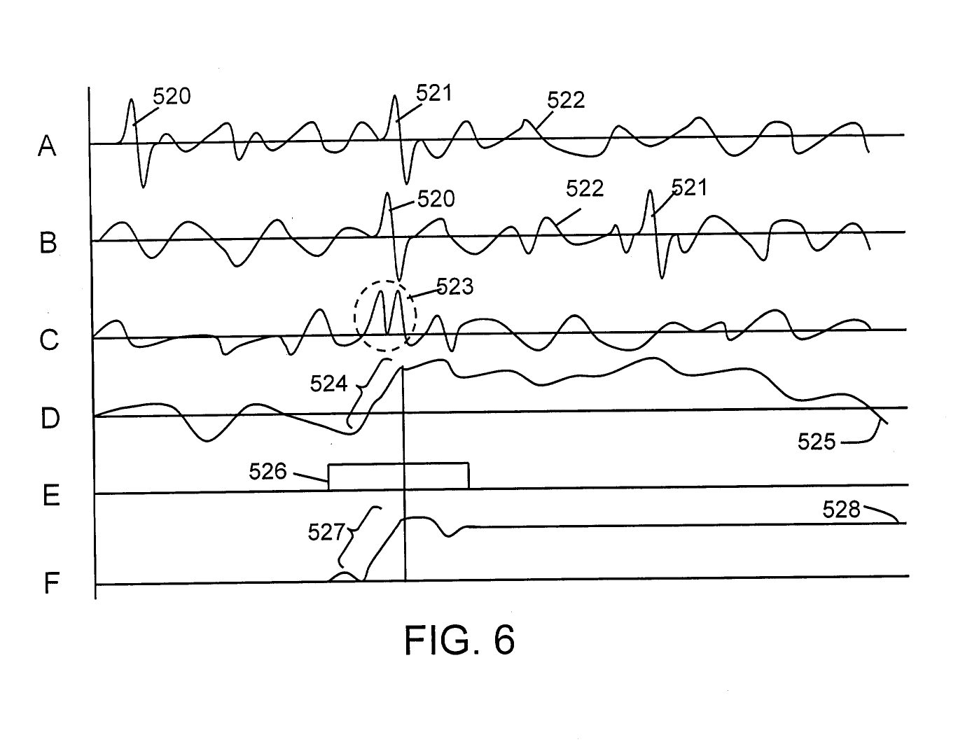

FIG. 6 shows the noise captured during a correlation period. Referring to FIG. 6, Signal A comprises a reference pulse 520, a data pulse 521 and noise 522 over a bit interval. Signal B represents a delayed copy of Signal A. Signal C represents the multiplication result of multiplying Signal A by Signal B in the multiplier 45. Signal portion 523 is the result of multiplying the Signal A data pulse 521 by the Signal B reference pulse 522. Signal D represents the integral, or filtered result, of Signal C. Signal portion 524 is the result of integrating signal portion 523. Signal D shows that although the signal portion resulting from the multiplication of the desired signal was significant 524, the continued integration of noise can result in the integration result reversing polarity 525 and being detected in error.

Gated Transmit Reference

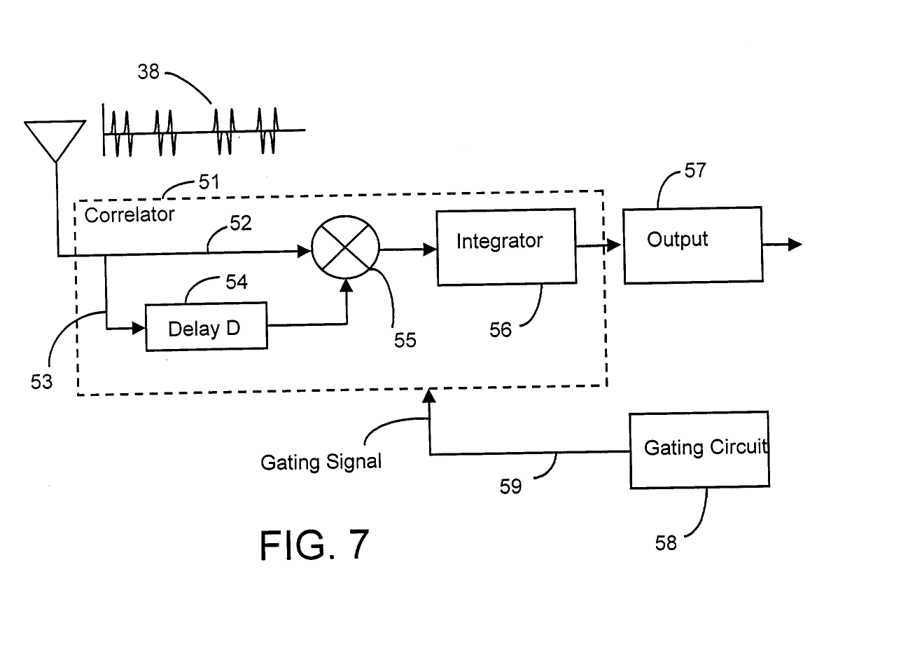

FIG. 7 shows a block diagram of a TR-UWB receiver 50 in accordance with the present invention. Similar to the TR-UWB receiver of FIG. 4, the TR-UWB receiver 50 receives the TR pulse train 38 as a sequence of reference and data pulse pairs. The reference and data pulses are separated from each other by the delay D, which is known to the receiver 50. As shown, the incoming TR pulses are applied to a correlator 51 along a forward path 52 and a delay path 53. The correlator 51 includes a delay circuit 54, a multiplier 55 and an integrator 56 that integrates the output of the multiplier 55. The forward path 52 is used for inputting the data pulses to a first input of the multiplier 55, and the delay path 53 delays the TR pulses for inputting them to a second input of the multiplier 55 through the delay circuit 54. The delay circuit 54, which can be implemented by a variety of structures, including coax, stripline, microstrip, SAW device, digital memory (with A/D system), or any other suitable flexible or non-flexible material, delays the TR pulses by time delay D. The delay path 53 may also include amplification circuitry (not shown) to counter delay losses. An output stage 57 processes the integrated output of the multiplier to generate a baseband signal and demodulates the baseband signal to recover the transmitted binary data.

According to one aspect of the present invention, the TR receiver includes a gating circuit 58 that generates a gating signal 59 to reject the noise during a portion of the correlation. In other words, the gating circuit limits the interval and amount of noise captured during correlation. As herein defined, gating means opening a path to limit the amount of noise captured along a signal path. In one exemplary embodiment, a gating signal generated during a gating time interval is relative to the timing of the reference and data pulses. For example, the gating signal can be synchronized with the reference pulse. Preferably, the gating circuit limits capturing the TR pulse noise prior to the integration process. As a result, the present invention reduces time bandwidth losses, as the amount of captured noise is minimized.

This process can be further understood by referring again to FIG. 6. In FIG. 6, Signal E represents a gating pulse. The effect of the gating pulse 526 is to zero the input to the integrator 56 except during a gating period 527. Signal F represents the output of the integrator 56 when a gating pulse 527 is used. The gating pulse 527 is placed to enable the signal to integrate and to disable integration outside of the signal period to minimize noise. Thus, the signal portion 523 dominates the integration and the integrator 56 output value at the end of the gating period 526 is held to the end of the bit interval 528.

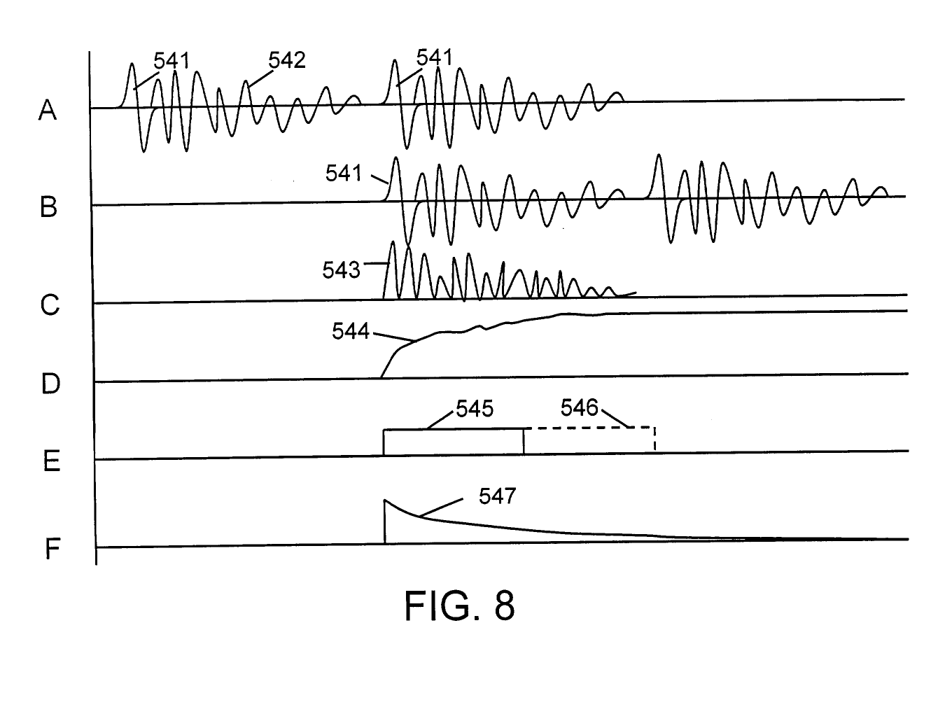

The gating process can be adapted to achieve a desired amount of SNR increase. As shown in FIG. 8, the gating time interval can be fixed or variable to adapt to various multipath environments. Consequently, the gating signal width can be fixed or variable depending upon multipath characteristics of the incoming TR pulses. In this way, resistance to interference results from higher signal strength, thereby producing higher throughput capacity, among other things. In another embodiment, the fixed time interval corresponds to the width of the reference pulse. In yet another embodiment, the gating signal can be synchronous with the reference pulse. Also, as shown in FIG. 8, various gating profiles can be used to increase the SNR. A gating profile can be based on a weighting function that approximates the envelope of the multipath delay and varies the gate value between one and zero. Alternatively, the gating profiles can be rectangular, ramp, exponential, l/t exp n, or any combination thereof.

Referring to FIG. 8, Signal A represents a TR signal as received in a multipath environment in the absence of noise. Each pulse is received as a direct path signal 541 and multiple reflections 542. Signal B represents a delayed copy of Signal A, which includes delayed reflections as well. Signal C represents the output 543 of the multiplier 55 showing that the pulse and multipath are both synchronous and produce positive multiplication results. Signal D represents the output of the integrator 56 and shows the integration of direct path 541 and multipath 542 signals to produce a combined result 544. Thus it is desirable to include at least some of the multipath 542 within a gating period 545 in addition to the direct path signal 541. Signal E represents a gating pulse 545. The gating pulse comprises a fixed portion 545 and a variable portion 546. Either or both may be implemented. The width of the gating period may be fixed based on a predetermined value established during the design process, or may be variable and may be established later, or established dynamically according to environment characterization or according to a performance feedback algorithm.

It may be appreciated that if the gating pulse 545 extends to the weakest multipath reflection signals 541, there will come a point of diminishing returns in that the incremental noise will exceed the incremental signal gained for an increasing gate interval 546. More particularly, an incremental gate interval 546 may be weighted according to measured or expected signal strength or voltage SNR. Accordingly, Signal F represents an exemplary gating profile 547 for weighting the gating signal. In a preferred embodiment, the gating profile 547 matches a mean SNR profile across the total received signal. The profile of the gating period may be fixed based on a predetermined value established during the design process, or may be variable and may be established later, or established dynamically according to environment characterization or according to a performance feedback algorithm.

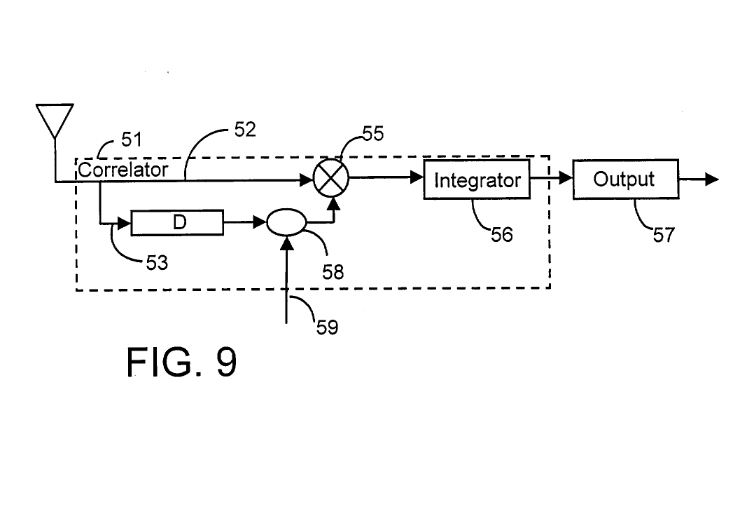

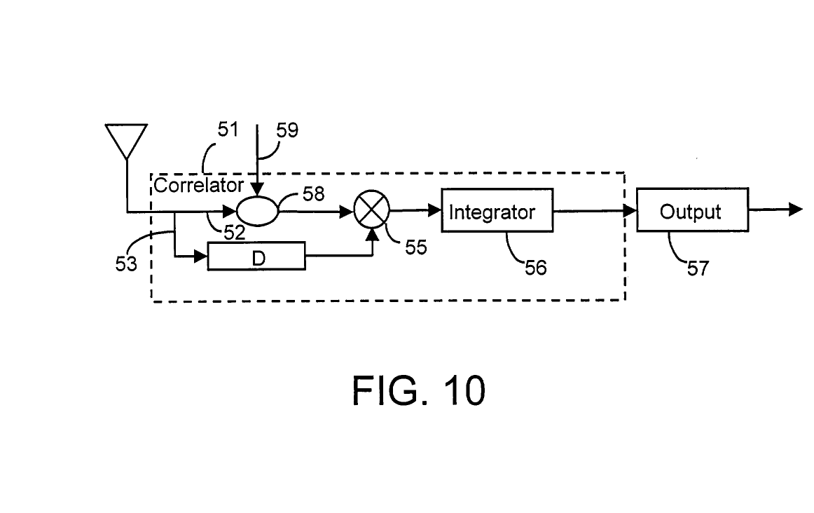

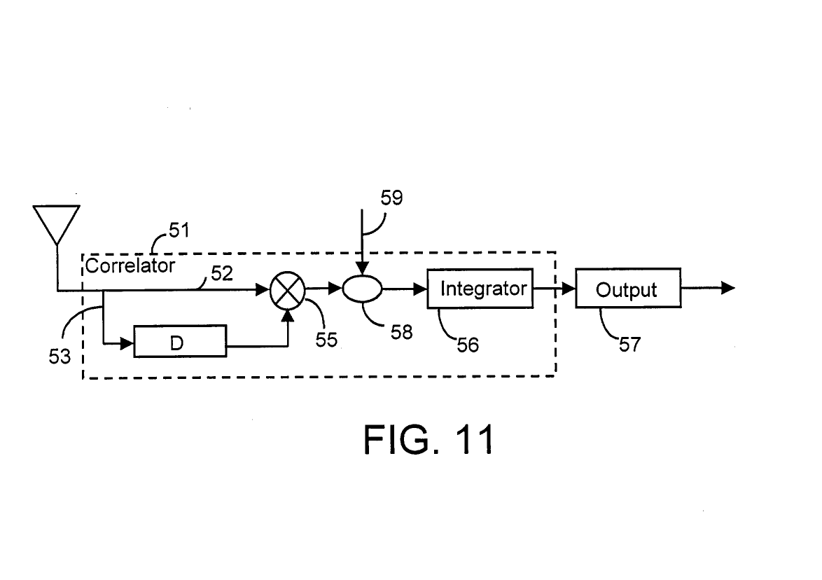

The gating circuit 58 can be implemented at various points of the correlation process, for example, in the forward path 52, delay path 53, or at the output of the multiplier 55. FIG. 9 shows the gating circuit 58 being positioned on the delay path 53 prior to the multiplier 55. FIG. 10 shows the gating circuit 58 being positioned on the forward path 52. FIG. 11 shows the gating circuit 58 being implemented at the output of the multiplier 55 prior to the integrator 56. It can be appreciated that the gating function in all three embodiments reduces the captured noise when correlating the reference and data pulses prior to integration.

It is an advantage of TR systems that the receiver does not need to acquire and track to the precision of a pulse or sub-pulse timing. This is accomplished by the delay element D. However, it is still necessary to acquire to the bit, word, message and higher levels. These higher levels, however are much more forgiving in the timing requirement. Thus TR systems allow for lower cost timing references than might otherwise be required in a conventional synchronous receiver (RS) system. One method of tracking for a non-gated system is disclosed in U.S. patent application Publication Number US 2001/0053175 A1, entitled “ULTRA-WIDEBAND COMMUNICATIONS SYSTEM.” which is hereby incorporated herein by reference.

Gated TR UWB systems, however, require alignment of the gate with respect to the desired signal. This requires an acquisition step and a tracking process to maintain this timing once it is established.

Gate Timing Acquisition

In one embodiment, the gate function is turned off during acquisition (or equivalently, the gate is opened 100% such that reception is always enabled) and the gate function is turned on when a signal is detected. In this embodiment, it may be desirable to utilize a lower data rate with higher integration gain to overcome the higher noise received with the fully open receiver.

Once the signal is detected, a gate timing position is needed to maintain operation. If the timing is off, the gate may not occur when the signal is present, which would disable reception. To overcome this, a timing search procedure may be implemented. In one embodiment of such search procedure, multiple gate positions are tried in sequence to ascertain which gate position results in the highest received signal. For example, in a system with a pulse pair repetition time of 100 ns and a gate time of 10 ns, a first gate position of 0 to 10 ns would be tried to see if signal is detected. If so, this position may be established for communication and a tracking algorithm may be engaged to maintain timing. If not, a second position starting at 5 ns to 15 ns would be tried. An overlap of time intervals is optional, but preferred to handle the situation that the signal may be coincident with the edge of the interval. This process continues until the signal is found, and may continue through several findings of the signal until a strongest signal is determined.

In an alternative embodiment, the gate timing may be reduced from 100% by halves or another fraction until the signal is no longer found, and then return to the state which detected signal. For example, using the 100 ns pulse repetition time as before, once a signal is detected with a 100 ns window, the window would be reduced to 50 ns from 0 to 50 ns. If the signal were no longer detected, the alternative window 50 to 100 ns would be tried. In all probability, one of the windows would detect the signal, but if neither detects the signal, a shifted window could be tried or a return to 100 ns could be tried to see if the signal remains present or if the detection was a false alarm. If the signal were found in one of the 50 ns windows, for instance the 0 to 50 ns window, then the window size would be reduced by half again to 25 ns. Thus, a 0 to 25 ns window would be established and checked for signal. This process would continue until a system limit is reached or until signal performance diminishes.

In an alternative embodiment, the gate is turned on during acquisition and the gate is stepped or slewed across the search interval and upon completing the search interval, repeating the process continuously until a signal is found. When a signal is found, the search stepping or slewing is stopped and a tracking algorithm may be engaged. In this embodiment, the data rate for acquisition may be close to or equal to the data rate for communication because the noise is reduced by the gate during the search process. This method may also be followed by a further gate reduction process to refine the gate size.

Gate Tracking

Generally, once a signal is acquired, it is desired to maintain track on the signal for a time to prevent the signal from drifting outside of the gate and being lost before the message is complete. This is not always necessary, however, as in the case of a very short message or a wide gate or some outside source for synchronization, but most systems will likely benefit from a tracking system.

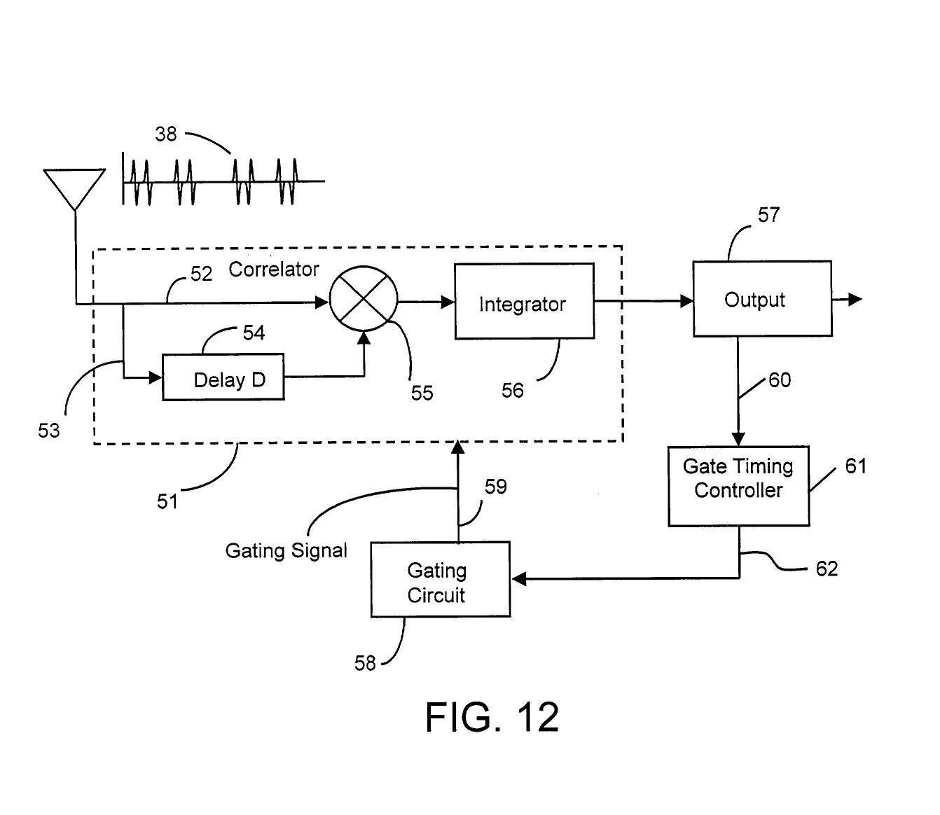

FIG. 12 represents a TR receiver system employing tracking in accordance with the present invention. Operation of the system of FIG. 12 is substantially similar to that of FIG. 7 where the blocks have like names.

The output block 57 provides a signal performance measurement 60, such as signal strength, to a gate timing controller 61, which may contain a filter or other algorithm to control loop dynamics. The output of the gate timing controller 61 feeds the gate timing circuit, which controls the time positioning of the gate.

In one embodiment, the gate is displaced in time periodically and a signal performance parameter such as signal strength or signal to noise ratio or bit error rate is evaluated synchronously with the periodic displacement of the gate position. An error signal resulting from this performance parameter evaluation is then provided to a control system to position the nominal gate position more advantageously based on the error signal. The control system may be a control loop filter that averages the error signal over time to reduce noise in the control loop and to insure proper feedback dynamics. The operation of this system may be understood more clearly by example. Assuming a system with a 100 ns average pulse pair interval and a 10 ns gate window, the gate may be shifted plus or minus one nanosecond at a 100 kHz rate. This would be 5 μs shifted 1 ns in the plus direction followed by 5 μs shifted 1 ns in the minus direction. During the 5 μs positive shift, the received signal would be evaluated for signal strength to yield positive shift signal strength. During the 5 μs negative shift the received signal would be evaluated for signal strength to yield negative shift signal strength. The positive shift signal strength and negative shift signal strength would then be compared by, for instance, subtraction. The result would then be utilized to control a timing system in a direction to favor improving the signal strength. Thus, if the positive shift signal strength is higher, the timing of subsequent gate positions may be increased by, for instance, one nanosecond until a new error signal is determined. In this way, the gate signal is kept within a range encompassing the received signal in the presence of slight timing drift between the transmitter and receiver systems.

Multiplex Gating

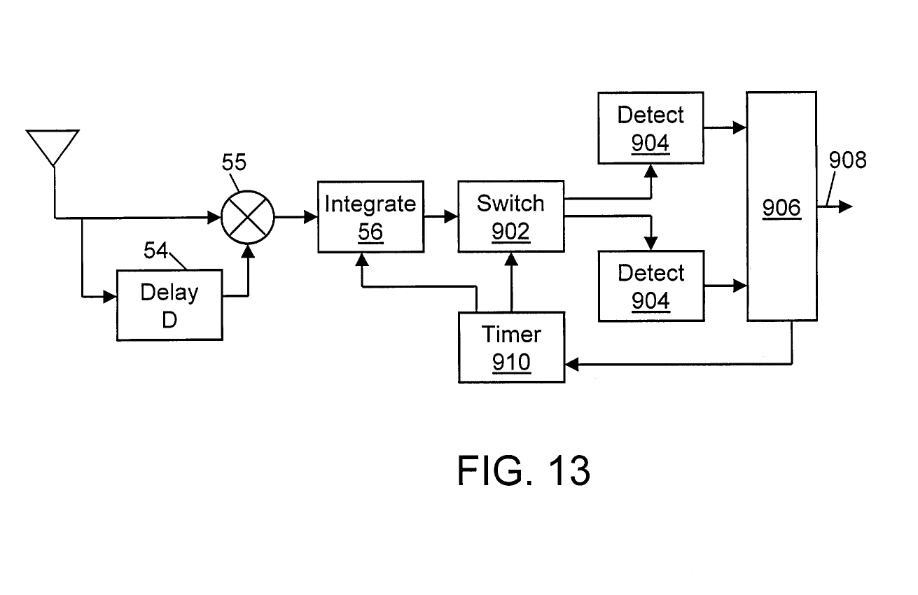

FIG. 13 illustrates a parallel receiver that can receive multiple gate times using a single shared front end. In brief, multiple parallel gate receivers are operated on different gate time intervals to cover more of the available time. In a preferred embodiment, the receivers cover 100% of the available time. For example, a two-receiver system may have a gate time of 50% each, the gate times are not concurrent or overlapping, so that the total time covered is 100%. Alternatively, a ten-gate receiver may operate each gate channel 10% of the time to total 100%.

The parallel gate architecture has advantages for acquisition as well as receiving data. During acquisition, a single gate system must search for a time on each gate offset interval to receive a signal with unknown time offset. The parallel gate receiver can receive all time offset values simultaneously using minimum parallel resources to cover the offset dimension. A non-gated TR receiver could also receive all offsets, but it suffers additional noise susceptibility and may not receive the weakest transmitters. The parallel gate receiver, however, may receive all offsets with significant sensitivity gain. A two parallel gate receiver, for instance, rejects half of the noise. Alternatively, a ten parallel gate receiver rejects 90% of the noise power.

In receive mode, if only one transmitter needs to be received, one channel may be utilized to receive the transmitter and the timing may track that transmitter. If multiple transmitters must be tracked, then the tracking may not be synchronous with a given gate time and a given receiver. To accommodate this gate slippage, adjacent gate times can be merged (turned on simultaneously) to handle the crossover as a signal transitions from one gate to another. In an alternative embodiment, two sets of gates, one set centered on the transition points of the other may be used in a manner similar to in phase and quadrature processing to assure all time intervals are covered.

Referring to FIG. 13, the signal is received through the front end up to the integrator as has been described in FIG. 7. The output of the integrator is sampled and, in a preferred embodiment, multiplexed among a number of receiver processing blocks (for example, two as shown in FIG. 13), which provide further signal summation and detection. The output of the receiver block is then passed to a controller that coordinates the receivers and the gating clock. The controller determines which, if any of the receiver channels contain a usable signal and provides tracking in accordance with the best channel. The best channel is also selected as output.

Spectrum Spreading

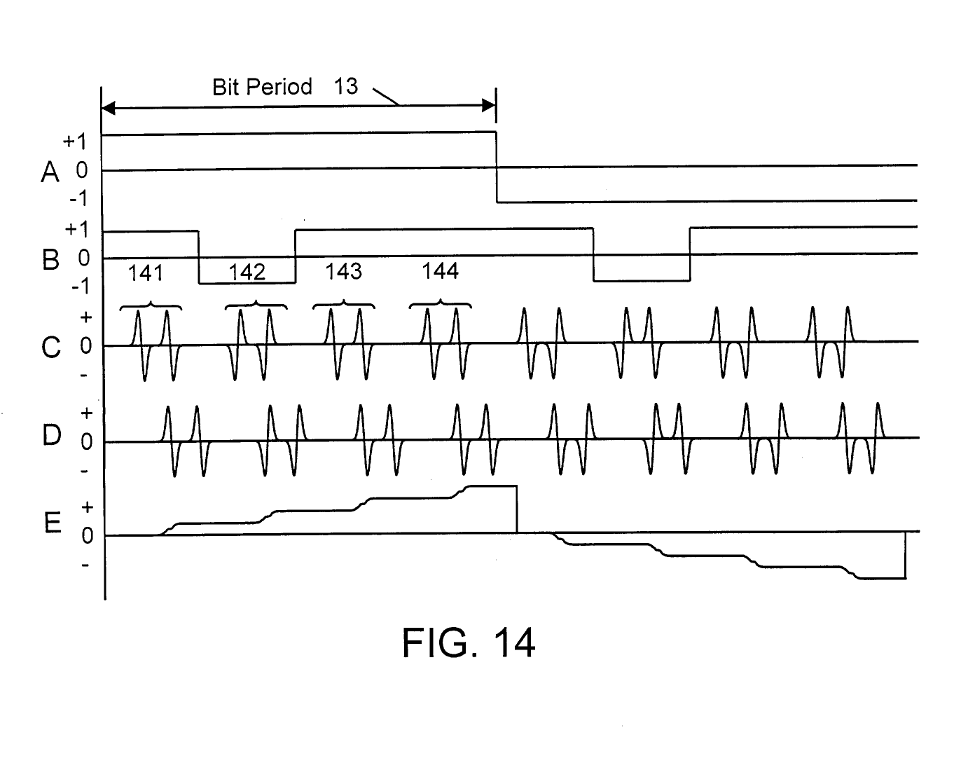

A further embodiment is shown in FIG. 14. illustrates a spectrum spreading code applied to a modulated TR pulse train similar to that of FIG. 1A. Referring to FIG. 14, Signal A represents an exemplary data signal showing a data “1” state as a positive 1 and a data “0” state as a negative 1. Signal B represents an exemplary spectrum spreading code comprising four states: +1,−1,+1,+1 and repeated for each data bit. The code is applied to each pulse pair to change the polarity of both the reference and data pulses. For example, pulse pairs 141,142,143, 144 would be all of positive (“positive” here means positive first half cycle) without application of the code of signal B; however, with application of the code as shown in signal C the polarities are +, −, ++ for signals 141, 142, 143, 144 respectively. Signal C represents a received forward path signal (42 of FIG. 4) with both data (signal A) and code (signal B) modulation. Signal D represents a delayed copy of Signal C as processed by delay circuit 44. It can be seen that the reference pulses of Signal D arrive at the multiplier 45 at the same time as the data pulses of Signal C. Signal E illustrates the output of the multiply and integrate process of FIG. 4. It can be seen from Signal D that applying the spectrum spreading code in the manner shown had no effect on the output of the multiply and integrate stage. This is because inverting a pulse pair has no effect on the integrated output. Thus, a spectrum spreading code can be applied in this manner at the transmitter to effect spectrum spreading with no change required in the receiver. Suitable codes for spectrum spreading in this manner include Barker, Kasami, Gold, PN (maximal length shift register codes) and other codes with known good spectral properties.

Differential Pulse

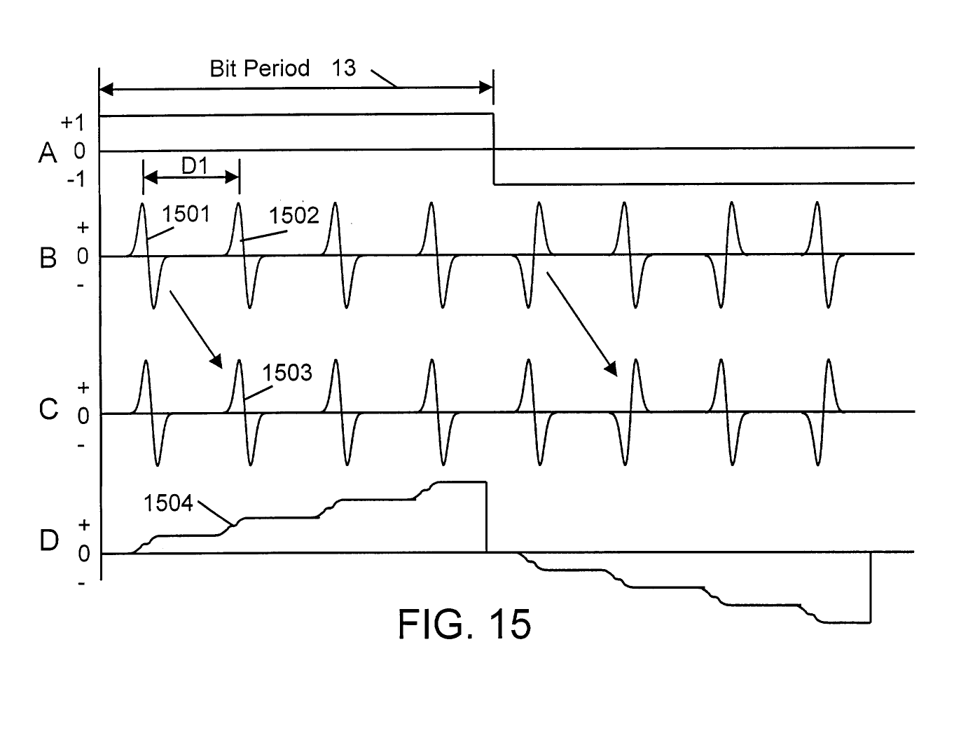

A further embodiment of the invention is shown in FIG. 15, which illustrates a differential signaling method that does not depend on a reference pulse. Referring to FIG. 15, Signal A represents a data signal. Signal B represents a resulting modulated pulse train showing four pulses per bit with pulse separation D1. Signal C represents a delayed copy of signal B delayed by delay D. Signal D illustrates a resulting integrator output from a receiver as shown in FIG. 4. For example, data pulse 1501 is delayed by delay D1 and becomes delayed pulse 1503. Data pulse 1502 and delayed data pulse 1503 are multiplied and the integrated result is shown as the increment 1504. Thus, if the pulse-to-pulse time spacing is constant, the reference pulse need not be sent, resulting in greater efficiency since every pulse of the transmitted signal is modulated by data.

Feedback Noise Reduction

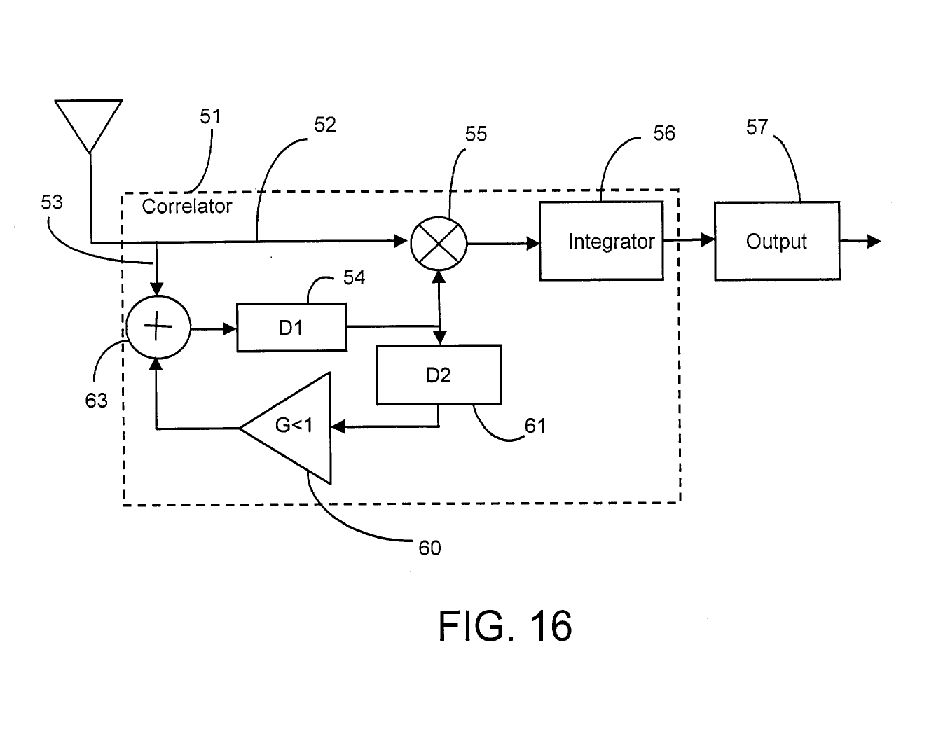

According to another aspect of the invention, the TR receiver includes feedback that enhances reference signals by coherent addition to improve reference signal SNR and thus improve overall receiver SNR performance. This aspect can be better understood with reference to FIG. 16, which is a simplified block diagram illustrating feedback noise reduction in accordance with the present invention. Referring to FIG. 16, a received signal 38 is split into two paths, a direct path 52 and a delayed path 53. The direct path is fed directly to a first input of a multiplier 55. The delayed path is fed through a summing junction 63 and then through a delay D1 54 to a second input of the multiplier 55. Delay D1 is equal to the pulse delay D from reference pulse to data pulse. The output of delay D1 is also fed through a second delay D2. The output of the delay D2 is fed through a gain stage to the summing junction creating a feedback loop linking D1, D2, the gain stage and the summing junction. The gain is adjusted so that the closed loop gain meets the performance desired. In a preferred embodiment, the closed loop gain is just less than one for maximum coherent addition with no oscillation. D2 is configured so that D1+D2 is the time from reference-pulse-to-reference-pulse so that the feedback loop is coherent at the reference pulse repeat time, i.e., when a reference pulse arrives at the summing junction, because the delays 54 and 61 are just equal to the reference pulse to reference pulse delay, the previous reference pulse is also arriving at the summing junction so that the two pulses add. Furthermore, reference pulses from two, three, four, and N times back in time are summing at the summing node. If the gain is less than one, each reference pulse back in history is reduced by the gain to the Nth power so that after a while, historical pulses can be ignored. For example, assuming a gain of 0.5, a pulse first passing from the input through the summing node will have strength of one. After passing through the delays and gain stage, it arrives at the summing node with strength of 0.5. After passing through the loop again, the pulse has a strength of 0.25 and, so on. After a number of pulses have accumulated in the loop, the signal strength of the reference pulse is 1+0.5+0.25+0.125 . . . =2 in the limit. The associated noise, however, is not coherent so its sum is not 2, but is somewhat less, improving the signal to noise. In another example with a gain of 0.9, the pulses will be 1+0.9+0.81+0.73+ . . . =10 in the limit. Again the noise will not be coherent and will be somewhat less than 10. Thus, the feedback loop produces a reference pulse at the summing node that is synchronous with the received signal and has an improved signal to noise ratio. This reference pulse is delayed by delay D1 and fed to the second input of the multiplier to detect the direct path signal 52 yielding an improved signal to noise ratio output.

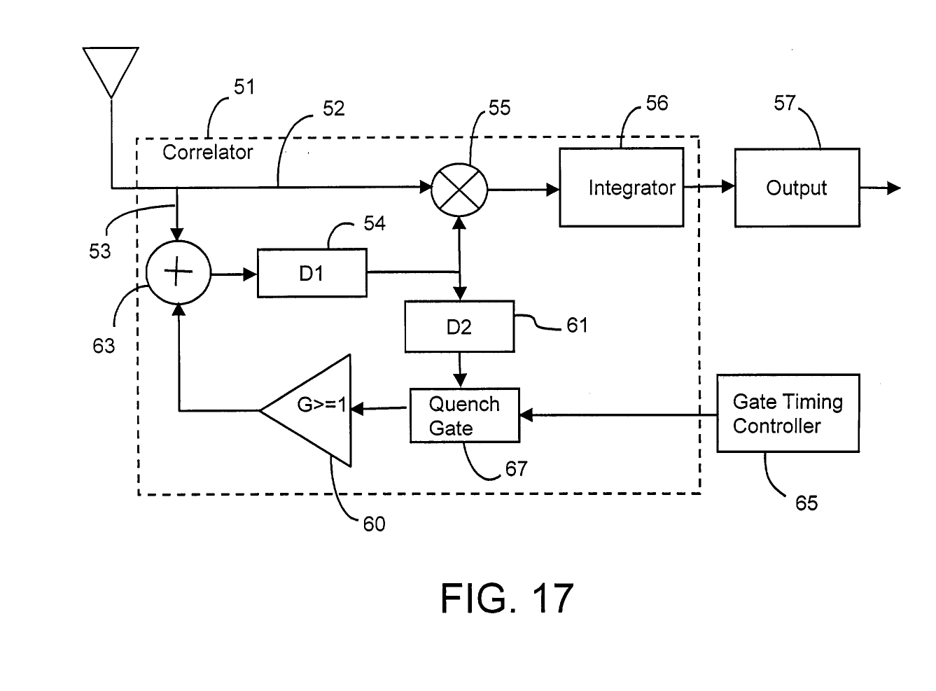

A further embodiment of the invention includes quench gating to further control the reduction of feedback noise. FIG. 17 illustrates quench gating in conjunction with feedback noise reduction. As shown in FIG. 17, this concept is a hybrid approach that combines the gating circuitry 58 and the feed back circuitry 60 described above. The feed back ciruitry 60 is disposed across the delay circuit 54. The quench gating circuit 67, responsive to a gate timing controller 65 is used to reduce the loop gain to control the performance of the feedback loop. An advantage of this arrangement is that the loop gain can be placed very close to 1 or may even be greater than one with harmless oscillation. This property is achieved by periodically quenching the loop to destroy oscillations before they become excessive, or periodically enabling the loop for short periods of time that are too short for the oscillations to build to high amplitude. The existence of the quench gating allows the design to be targeted at a nominal gain of one without undue concern for oscillations.

The quenching operation may be implemented in conjunction with the gating shown in FIG. 7. The quenching, must, however include the time when the quench gate is open to suppress oscillations during this time and from one gate to the next.

In an alternative embodiment, the quenching may allow oscillation to a controlled level by feeding back a measure of the amplitude of the output of the amplifier 60 to control the attenuation of the quench gate 67.

From the foregoing description, it would be appreciated that the present invention improves received signal quality that results in improved data recovery in TR pulse trains. By limiting the captured noise of TR pulse pairs, the correlation of the reference and data pulses becomes more robust resulting in improved binary data detection. Also the feed back mechanism that combines forward and feed back noise non-coherently further improves the received signal quality.

It will be understood that the invention is not limited to the particular embodiments described above and that modifications may be made by persons skilled in the art. The scope of the invention is determined by the following claims, and any and all modifications that fall within that scope are intended to be included therein.

1. A TR-UWB receiver for receiving a TR signal that includes reference and data pulses separated by a delay, D, comprising:
a multiplier having a first input for receiving a data pulse;
a delay circuit for delaying a reference pulse and inputting it to a second input of the multiplier;
an integrator for integrating the output of the multiplier;
at least one of a gating circuit for limiting noise prior to the integrator in response to a gating signal generated during a gating time interval; and a feedback circuit for combining a forward and feedback noise.

2. The TR-UWB receiver of claim 1, wherein the gating time interval is relative to the time interval between the reference and data pulses.

3. The TR-UWB receiver of claim 1, wherein the gating time interval is at least one of a fixed and variable time intervals.

4. The TR-UWB receiver of claim 3, wherein the fixed time interval corresponds to the width of the reference pulse.

5. The TR-UWB receiver of claim 1, wherein the gating signal is generated synchronous with the reference pulse.

6. The TR-UWB receiver of claim 1, wherein the gating circuit is positioned prior to the first input of the multiplier.

7. The TR-UWB receiver of claim 1, wherein the gating circuit is positioned prior to the second input of the multiplier.

8. The TR-UWB received of claim 1, where in the gating circuit is positioned prior to the integrator.

9. The TR-UWB receiver of claim 1, wherein the gating signal is generated based on a weighting function.

10. The TR-UWB receiver of claim 9, wherein the weighting function approximates a multipath delay envelope.

11. The TR-UWB receiver of claim 1, wherein the feed back circuit has a gain of less than one.

12. The TR-UWB receiver of claim 1, wherein the reference and data pulses are adjacent to each other.

13. The TR-UWB receiver of claim 1, wherein the reference and data pulses are non-adjacent to each other.

14. A method for increasing received signal-to-noise ratio in a TR-UWB system comprising the steps of:
receiving TR pulses comprising reference and data pulses separated by a delay, D;
correlating a data pulse and a reference pulse in accordance with the delay D; and at least one of the steps of:
generating a gating signal generated during a gating time interval to limit the amount of captured noise during correlation; and
combining a forward and feedback noise during correlation.

15. The method of claim 14, wherein correlation comprises:
multiplying the data pulse with a delayed, D, reference pulse;
integrating the multiplication result; and
limiting noise capture prior to integrating.

16. The method of claim 14, wherein the gating time interval is relative to the timing of the reference and data pulses.

17. The method of claim 13, wherein the gating time interval is at least one of a fixed and variable time intervals.

18. The method of claim 17, wherein the fixed time interval corresponds to the width of the reference pulse.

19. The method of claim 14, wherein the gating signal is generated synchronous with the reference pulse.

20. The method of claim 14, wherein the gating signal is generated based on a weighting function.

21. The method of claim 20, wherein the weighting function approximates a multipath delay envelope.

22. The method of claim 14, wherein the reference and data pulses are adjacent to each other.

23. The method of claim 14, wherein the reference and data pulses are non-adjacent to each other.

24. A method for receiving TR pulses comprising reference and data pulses separated by a delay, the method comprising the steps of:
inputting a data pulse to a first input of a multiplier via a first signal path;
delaying a reference pulse to be inputted to a second input of the multiplier in accordance with the delay via a second signal path; and
increasing the signal-to-noise ratio of the delayed reference pulse presented to the multiplier via the second path.

25. The method of claim 24, wherein the signal-to-noise ratio is increased by gating at least a portion of the reference pulse.

26. The method of claim 24, wherein the gating of at least a portion of the reference pulse is in accordance with a gating time interval.

27. The method of claim 23, wherein the gating is in accordance with a weighting factor.

28. The method of claim 26, wherein the gating time interval is a fixed time interval.

29. The method of claim 28, wherein the fixed time interval corresponds to the width of the reference pulse.

30. The method of claim 26, wherein the gating time interval is variable.

31. The method of claim 24 further comprising generating a gating signal that is synchronous with the reference pulse.

32. The method of claim 24, wherein the signal-to-noise ratio is increased by feeding back the delayed reference pulse.
